(19) United States
(12) Patent Application Publication
(10) Pub. No.: US 2018/0319350 A1
(43) Pub. Date: Nov. 8, 2018

(54) Automobile Accessory Mounting Support

(71) Applicants: Compagnie Plastic Omnium, Lyon (FR); Yanfeng Plastic Omnium Automotive Exterior Systems Co., Ltd., Shanghai (CN)

(72) Inventors: Jian Ji, Shanghai (CN); Heng Wang, Shanghai (CN)

(73) Assignees: Compagnie Plastic Omnium, Lyon (FR); Yanfeng Plastic Omnium Automotive Exterior Systems Co., Ltd., Shanghai (CN)

(21) Appl. No.: 15/768,180

(22) PCT Filed: Aug. 10, 2016
(86) PCT No.: PCT/CN2016/094332

§ 371 Date: Apr. 13, 2018

(30) Foreign Application Priority Data
Oct. 13, 2015 (CN) 201520800404.9

(51) Int. Cl. B60R 11/04; B60R 19/48

(52) U.S. Cl. CPC B60R 11/04; B60R 2011/004; B60R 19/483

(57) ABSTRACT

The present invention relates to the field of automobile parts, and more particularly to an automobile accessory mounting support having: a body including a base and a tubular structure for housing the accessory, wherein one end of the tubular structure is fixed to the base and the other end is provided with one or more snapping members; and a cover for cooperating with the body, which is provided with a snapping structure for cooperating with the snapping members.

### FIELD OF THE INVENTION

The present invention relates to the field of automobile parts, and more particularly to an automobile accessory mounting support configured for fixing an accessory (such as a camera) to the vehicle in an easy and reliable way.

### BACKGROUND OF THE INVENTION

Accessories are often mounted in an automobile for different purposes. For example, a camera is usually installed in the front or rear portion of an automobile. For instance, a rear-view camera is a safety-assist functional device that prevents an automobile body from colliding with an obstacle.

With the development of automobile technologies and the tendency of automobiles to be light-weighted, more and more plastic structural parts are widely applied to automobiles. It is known from the prior art that an accessory is often mounted on a vehicle through a plastic one-piece support configured for positioning and fixing the accessory. In order to be received by such a support, the accessory to be mounted should generally be equipped with additional fixing means to cooperate with those of the support. The assembling of the accessory in the support is usually complicated, leading to a high cost for manufacturing a vehicle. Moreover, typically, such a support cannot guarantee a good tightness between the accessory and the support.

### SUMMARY OF THE INVENTION

The object of the present invention is to provide a new support through which an accessory (even a standard one) can be fixed to or detached from a vehicle exterior part in an easy and reliable way.

To this end, the present invention provides an automobile accessory mounting support, comprising:

a body including a base and a tubular structure for housing the accessory, wherein one end of the tubular structure is fixed to the base and the other end is provided with one or more snapping members; and

a cover for cooperating with the body, which is provided with a snapping structure for cooperating with the snapping members.

The fact that the support is formed in two parts (a part intended to constitute an interface with the automobile part for receiving the accessory and a part intended to position and fix the accessory) allows to mount a standard accessory (eg. a camera not dedicated to automobiles) to a vehicle exterior part or detach it therefrom more easily and reliably. Further, the accessory to be mounted does not have to be equipped with additional fixing means. Still further, the tubular structure limits the position of the accessory and protects the same together with the cover, thus increasing the service life of the accessory. Moreover, the fact that the body and cover of the support are snapped into each other by means of snapping members and snapping structures renders the assembling reliable and easily detachable for the sake of convenient use.

The term “accessory” is understood to mean any device having a particular function when mounted in an automobile, including but not limited to any detection means intended to for example prevent an automobile body from colliding with an obstacle, such as a camera, an ultrasonic sensor, an infrared sensor and the like.

The automobile accessory mounting support can further comprise one or more following features, taken alone or together:

A first through hole is provided in the base for cooperating with a lens of the camera.

The base has a first face and a second face opposite to each other, the first face being configured as a profiling face (having a form complementary to that of a face against which it abuts) for fitting the inside of an accessory receiving portion, particularly an automobile rear sill, a pumper skin, a strip. This allows to guarantee a high assembling accuracy between the support and the automobile part.

The snapping members are distributed uniformly on said the other end of the tubular structure.

The support further comprising a seal arranged in the tubular structure. The seal prevents impurities such as rain from entering into the accessory, thereby ensuring that the accessory has a longer service life. Moreover, it can absorb most of vibrations subjected by the accessory so as to stabilize it, assuring a higher quality of image captured by the accessory in the case of a camera.

The cover is provided with a second through hole for cooperating with wirings of the accessory.

An inner wall of the tubular structure is provided with one or more protrusions, one end of which being connected to the base and the other end being configured as a guiding slope.

The protrusions are rib-like, preferably uniformly distributed circumferentially on the inner wall of the tubular structure, or constitute a annular structure projecting from the inner wall of the tubular structure.

The snapping member is substantially of “ [symbol] ” shape, and has two connecting arms connected with the tubular structure and a resilient arm arranged between the two connecting arms and spaced from the tubular structure, a free end of the resilient arm being configured as a hook-like structure.

The edges of the first face and the first through hole of the base protrude outwards to form a position-limiting boss.

The edge of the cover is bent to form a side wall, and a slot-like structure that extends through the side wall is provided in the cover at the second through hole.

A free end of the side wall is bent to form a position-limiting structure for cooperating with the second face of the base.

The second face of the base is provided with an error-proof rib, and a rib slot is provided in the side wall for cooperating with the error-proof rib.

### BRIEF DESCRIPTION OF THE DRAWINGS

FIG. 1 is a schematic exploded structural view of an embodiment of the present invention;

FIG. 2 is a schematic structural top view of an embodiment of the present invention;

FIG. 3 is a schematic cross-sectional structural view of FIG. 1 along the line A-A; and

FIG. 4 is a schematic cross-sectional structural view of an embodiment of the present invention.

In the drawings, the reference numeral 1 refers to a body (101 a base (101a a first face, 101b a second face, 101c a first through hole, 101d a position-limiting boss), 102 a tubular structure (102a a rib-like protrusion), 103 a snapping member (103a connecting arms, 103b a resilient arm)), 2 a camera (201 a lens, 202 wirings), 3 a seal, 4 a cover (401 a second through hole, 402 a snapping slot structure, 403 a side wall, 404 a slot-like structure, 405 a position-limiting structure), 5 an automobile rear sill (501 a mounting hole), and 6 an error-proof arrow.

### DETAILED DESCRIPTION OF THE EMBODIMENTS

The present invention will be further explained in detail based on the embodiments with reference to the drawings, given only in illustrative purpose.

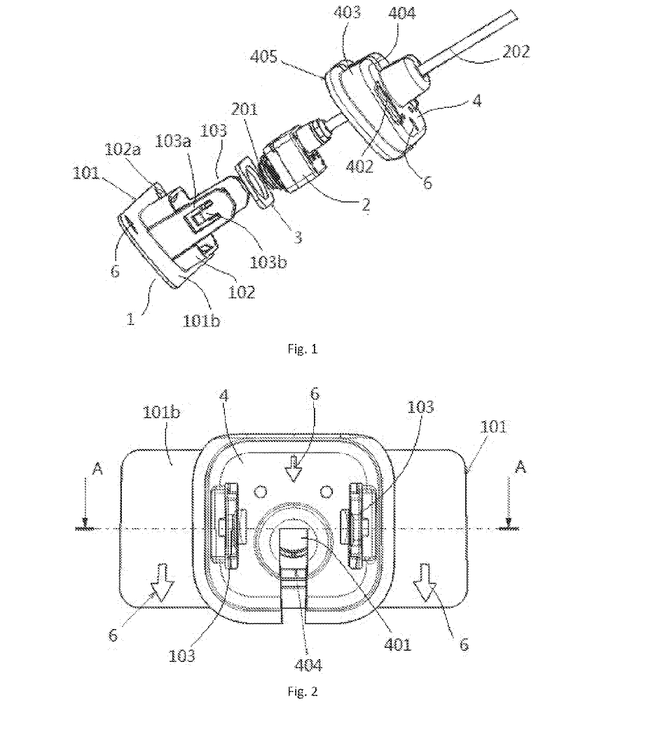

FIGS. 1 to 4 shows an automobile accessory mounting support according to an embodiment. In this embodiment, the support is for mounting a camera 2 on a rear sill 5 of a vehicle. It should be appreciated that those skilled in the art could easily design a support for mounting any other accessory (such as an ultrasonic sensor, an infrared sensor, etc.) on any suitable position of a vehicle, without departing from the scope of the present invention.

The mounting support comprises a body 1 including a base 101 and a tubular structure 102 for housing a camera 2, wherein one end of the tubular structure 102 is fixed to the base 101 and the other end is provided with a plurality of snapping members 103. In this illustrative example, as best seen in FIG. 1, there are two snapping members 103 uniformly distributed on said the other end of the tubular structure.

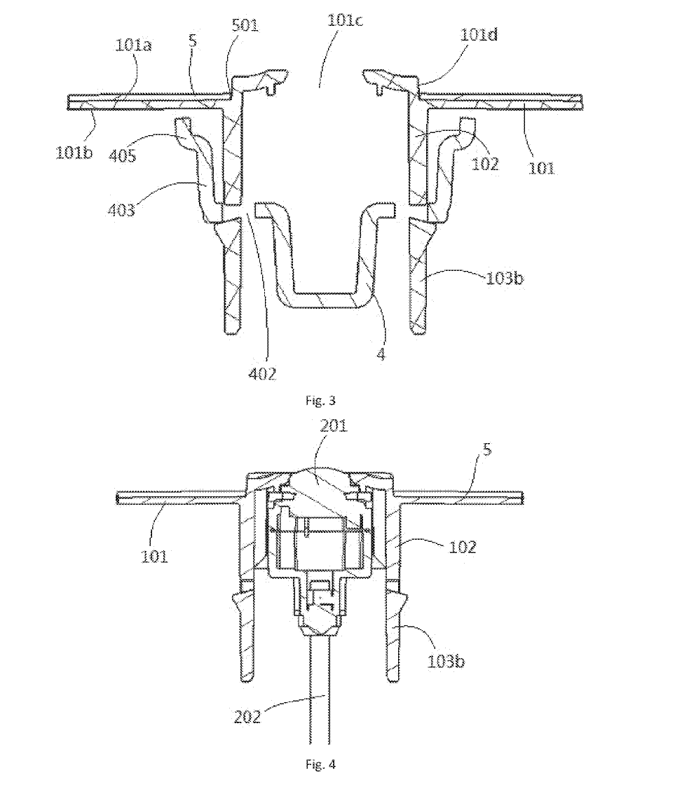

As shown in FIG. 3, a first through hole 101c is provided in the base 101 for cooperating with a lens 201 of the camera 2 and the base 101 has a first face 101a and a second face 101b opposite to each other, the first face 101a being configured as a profiling face for fitting the inside of an automobile rear sill 5. The mounting support can be assembled to the rear sill through any suitable techniques, such as welding (particularly laser welding), gluing, riveting, screwing, etc.

As shown in FIGS. 1 and 2, the mounting support further comprises a cover 4 for cooperating with the body 1. Preferably, the cover 4 may be provided with a second through hole 401 for cooperating with wirings 202 of the camera and a snapping slot structure 402 for cooperating with the snapping members 103.

As shown in FIG. 1, advantageously, the mounting support further comprises a seal 3 (eg., a resilient ring structure) arranged in the tubular structure 102 and compressed between the camera 2 and the tubular structure 102.

It can be contemplated that another seal is arranged between the camera 2 and the cover 4 so as to ensure a good tightness from rear side of the camera.

Preferably, the inner wall of the tubular structure 102 is provided with one or more protrusions 102a, one end of which being connected to the base and the other end being configured as a guiding slope. The protrusions 102a limit the position of the camera 2, thereby preventing the loosening of the camera 2 and making the assembling more reliable; the guiding slope may guide the camera 2 during the assembling, thereby increasing the assembling efficiency. In the embodiment shown in the figures, there are two rib-like protrusions, uniformly distributed circumferentially on the inner wall of the tubular structure. In a variant, the protrusions constitute an annular structure projecting from the inner wall of the tubular structure. Preferable, the protrusions are made of a soft material so that there are compressed between the tubular structure 102 and the camera, thereby ensuring an additional tightness therebetween.

Preferably, the snapping member 103 is substantially of “ [symbol] ” shape (FIG. 1) and has two connecting arms 103a connected with the tubular structure 102 and a resilient arm 103b arranged between the two connecting arms 103a and spaced from the tubular structure 102, and the free end of the resilient arm 103b is configured as a hook-like structure. When the cover 4 is snapped onto the body 1, the connecting arms 103a of the snapping members 103 guide the cover 4, thereby increasing the assembling efficiency.

Preferably, the edges of the first face 101a and the first through hole 101c of the base protrude outwards to form a position-limiting boss 101d, and a mounting hole 501 is provided in the automobile rear sill 5 for cooperating with the position-limiting boss 101d. Thanks to the position-limiting boss 101d, the accuracy of the assembling between the body 1 and the automobile rear sill 5 is enhanced.

Preferably, the edge of the cover 4 is bent to form a side wall 403, and a slot-like structure 404 that extends through the side wall 403 is provided in the cover 4 at the second through hole 401 so as to facilitate the bending of the wirings 202. In an example, the slot-like structure 404 has a width that is equal to the diameter of the second through hole 401. In another example, the slot-like structure 404 has a width that is greater than the diameter of the second through hole 401.

Preferably, the free end of the side wall 403 is bent to form a position-limiting structure 405 for cooperating with the second face 101b of the base. The position-limiting structure 405 prevents over-assembling between the body 1 and the cover 4.

Preferably, the second face 101b of the base is provided with an error-proof rib, and a rib slot is provided in the side wall 403 for cooperating with the error-proof rib.

Preferably, the second face 101b of the base and the cover 4 are both provided with an error-proof arrow 6. During the assembling, if the error-proof arrows 6 point to the same direction, the assembling is correct; otherwise, the assembling is wrong.

The above contents are detailed explanation to the present invention made on the basis of particular embodiments, and it should not be deemed that the embodiments of the present invention are limited thereto. Without departing from the concepts of the present invention, those ordinarily skilled in the art to which the present invention pertains may make various simple variations or replacements, which should be regarded as falling within the protection scope of the present invention.

1. An automobile camera mounting support, comprising:
a body including a base and a tubular structure for housing the camera, wherein one end of the tubular structure is fixed to the base and the other end is provided with one or more snapping members; and
a cover for cooperating with the body, which is provided with a snapping structure for cooperating with the snapping members.

2. (canceled)

3. The automobile camera mounting support according to claim 1, wherein a first through hole is provided in the base for cooperating with a lens of the camera.

4. The automobile camera mounting support according to claim 1, wherein the base has a first face and a second face opposite to each other, the first face being configured as a profiling face for fitting the inside of a camera receiving portion, particularly an automobile rear sill, a pumper skin, a strip.

5. The automobile camera mounting support according to claim 1, wherein the snapping members are distributed uniformly on said the other end of the tubular structure.

6. The automobile camera mounting support according to claim 1, further comprising a seal arranged in the tubular structure.

7. The automobile camera mounting support according to claim 3, wherein the cover is provided with a second through hole for cooperating with wirings of the camera.

8. The automobile camera mounting support according to claim 1, wherein an inner wall of the tubular structure is provided with one or more protrusions, one end of which being connected to the base and the other end being configured as a guiding slope.

9. The automobile camera mounting support according to claim 8, wherein the protrusions are rib-like, preferably uniformly distributed circumferentially on the inner wall of the tubular structure, or constitute an annular structure projecting from the inner wall of the tubular structure.

10. The automobile camera mounting support according to claim 1, wherein the snapping member is substantially of “ [symbol] ” shape, and has two connecting arms connected with the tubular structure and a resilient arm arranged between the two connecting arms and spaced from the tubular structure, a free end of the resilient arm being configured as a hook-like structure.

11. The automobile camera mounting support according to claim 3, wherein the edges of the first face and the first through hole of the base protrude outwards to form a position-limiting boss.

12. The automobile camera mounting support according to claim 7, wherein the edge of the cover is bent to form a side wall, and a slot-like structure that extends through the side wall is provided in the cover at the second through hole.

13. The automobile camera mounting support according to claim 1, wherein a free end of the side wall is bent to form a position-limiting structure for cooperating with the second face of the base.

14. The automobile camera mounting support according to claim 4, wherein the second face of the base is provided with an error-proof rib, and a rib slot is provided in the side wall for cooperating with the error-proof rib.
